(19) United States
(12) Patent Application Publication
(10) Pub. No.: US 2008/0309935 A1
(43) Pub. Date: Dec. 18, 2008

(54) Method for Methane Spectral Absorbance Calculation Using Sunlight

(76) Inventor: Bo Ling, Norfolk, MA (US)

Correspondence Address: MIGMA SYSTEMS, INC., 1600 PROVIDENCE HIGHWAY, WALPOLE, MA, 02081, US

(21) Appl. No.: 11/764,226

(22) Filed: Jun. 17, 2007

(51) Int. Cl. G01J 3/28

(52) U.S. Cl. 356/326

(57) ABSTRACT

A method and a system are provided for calculating the spectral absorbance using sunlight. With this method, methane (CH₄) in open air can be detected using NIR spectrometers. It does not require any laser illumination of methane molecules in an outdoor environment. Instead, sunlight is used as the light source. This system works from early morning to late evening under various weather conditions (sunny, partly cloudy, cloudy, windy, etc.). Although theoretical background and experimental procedure for methane (CH₄) absorbance is disclosed, the entire method can be applied to any other species as well when the wavelength range of interest overlaps with sunlight spectra.

### REFERENCES CITED

Ling, B., Zeifman, M., Hu, J. (2006), “A Practical and Inexpensive System for Natural Gas Leak Detection,” Proceedings of ISA Technical Conference, Houston, Tex.

O'Brien, J. J., Cao, H. (2002), “Cross sections from Absorption Spectra and Absorption Coefficients for Methane in the 750-940 nm Region Obtained by Intracavity Laser Spectroscopy,” Journal of Quantitative Spectroscopy and Radiative Transfer, 75, pp. 323-350.

Platt, U. (1994) “Differential optical absorption spectroscopy (DOAS),” in Air Monitoring by Spectroscopic Techniques,” M. W. Sigrist, ed., Chemical Analysis Series (Wiley, New York), Vol. 127.

Reichardt, T. A., W. Einfeld, and T. J. Kulp (2002): “Review of Remote Detection for Natural Gas Transmission Pipeline Leaks,” final report on “Evaluation of Active and Passive Gas Imagers for Transmission Pipeline Remote Leak Detection” project report, Sandia National Laboratory.

### BACKGROUND OF THE INVENTION

(1) Field of the Invention

The present invention generally relates to a new method to calculate the spectral absorbance utilizing sunlight without any other illumination sources. This invention more particularly relates to computer and/or electronic and mechanical methods and systems for detecting molecules in air, including methane (CH₄), when the wavelength range of interest overlaps with sunlight spectra.

(2) Background Information

In the US natural gas transport system, the underground piping includes approximately 400,000 miles of transmission pipelines and 1.4 million miles of distribution piping, while above-ground piping is located mainly at about 750 gas processing plants and some 3000 compressor stations (Reichardt, Einfeld, and Kulp 2002). These pipelines are often disrupted by leaks. Regulatory pressure is increasing to inspect transmission lines more frequently. Remote gas leak survey is a proactive way to prevent unnecessary loss of human life resulted from natural gas leaks.

Since the existing active detection system is too expensive and passive detection system is less reliable, a spectroscopic-optical-based system has been developed, which utilizes the sunlight to detect the methane within a specific wavelength range such as 850-950 nm (Ling, Zeifman and Hu 2006) or 1300-1700 nm. Being able to detect methane within this range is significant, which makes it possible to dramatically reduce the system cost associated with an expensive sensing instrument, an expensive laser device, and complex and costly system operations.

The leak detection technologies can be roughly divided into in-situ methods and remote sensing methods. The in-situ methods currently being used by gas utility companies include sensor-less methods such as observation of odor, unusual vegetation, or a hissing sound, and sensor-based methods that use either Combustible Gas Indicator (CGI) or Flame Ionization (FI) gas detector. Specifically, the most widely used gas leak survey tool is FI detector that uses a hydrogen fuel to power a small flame in a detector cell. A pump system is used to pass continuous air samples through the detector cell. If the air contains hydrocarbons such as natural gas, they will be burned or ionized in the hydrogen flame. FI detector is highly sensitive when it is close to the sample being tested.

There are two major techniques used for remote gas leak detection: (1) active detection, which requires illuminating the scene with a radiation source such as a laser, and (2) passive detection, which relies on radiative transfer resulted from the temperature difference that usually exists between the background and the target methane (CH₄) plume. Active detection removes the constraint of thermal difference, but requires a laser and a scattering surface behind the gas for echo signals. While passive methods allow a long range of detection with a relatively simple thermal imaging device, these methods rely upon a thermal flux between the gas plume and the ground surface below it.

As regulated by individual states in US, gas utility companies must perform gas leak surveys using a gas detection instrument covering various areas including:
(a) all mains, services, and transmission lines including the testing of the atmosphere near other utility (gas, electric, telephone, sewer, or water) boxes or manholes, and other underground structures;
(b) through cracks in paving and sidewalks;
(c) on all above ground piping;
(d) where a gas service line exists, a survey must be conducted at the building wall at the point of entrance; and
(e) within all buildings where gas leakage has been detected at the outside wall, at locations where escaping gas could potentially migrate into and accumulate inside the building.

Therefore, an efficient and reliable remote natural gas leak detector is desired.

### SUMMARY OF THE INVENTION

In one aspect, the present invention includes a method to estimate the number of vacuum references required for specific applications such as gas leak detection. In particular, a variable power supply is used to set the photon counts at desired levels. A pipe is used, together with a connected vacuum pump, to generate both air and vacuum environment inside the pipe. With this setting, both pipe references and corresponding vacuum references can be measured.

In another aspect, this invention includes a systematic procedure for collecting references. This procedure is made of six steps including light intensity change, photon counts measurement, vacuuming pipe, and measuring and recording both pipe and vacuum references.

In yet another aspect, this invention includes method to systematically build two libraries, one for the pipe references, and the other for the vacuum references. References in each library can be retrieved using index.

In still a further aspect, this invention includes a procedure to systematically estimate the vacuum reference associated with one particular solar reference measured. This procedure consists of four steps including solar reference measurement, matching pipe reference in the pipe reference library, retrieving vacuum reference from the vacuum reference library, and finally, use the matched vacuum reference and measured solar reference to estimate the absorbance.

### BRIEF DESCRIPTION OF THE DRAWING

FIG. 1 is a block diagram of overall system architecture using present invention detailed in this disclosure.

FIG. 2 is a block diagram of major components closely related the light source in present invention.

FIG. 3 shows the structure of light transmission device with fixtures and vacuum pump.

FIG. 4 shows an example of pipe references and corresponding vacuum references.

FIG. 5 shows the system setup in an actual application where solar reference is measured.

FIG. 6 shows an example of absorbance estimated using method disclosed in this invention.

### DETAILED DESCRIPTION

Beer-Lambert's law governs the estimation of spectral absorbance. It specifies the linear relationship between absorbance and concentration of absorbing species, including methane to be detected in the outdoor open air. The general Beer-Lambert's law is usually given as:

A_{λ}=ε_{λ}bc (1)

where A_{λ} is the absorbance, ε_{λ} is the absorptivity coefficient at wavelength λ, b is the path length of species (such as methane, CH₄), c is the concentration of the same species. It can be observed that absorbance is proportional to both path length and species concentration. One example of theoretical absorbance of methane can be found in (O'Brien 2002).

To obtain the absorbance from a spectrometer, one needs to first take the “dark” scan and “vacuum” scan. Basically, the “dark” scan will measure the light intensity in a totally dark environment while the “vacuum” scan is done in a vacuum environment. Mathematically, the absorbance at pixel n can be calculated using the following formula:

$${A}_{n} = - log ( \frac{{s}_{n} - {d}_{n}}{{v}_{n} - {d}_{n}} ) n = 1 , 2 , … , N$$

where N is the number of pixels supported by a spectrometer, sₙ is the real-time light intensity measurement from the spectrometer, vₙ is the light intensity measurement in the vacuum environment, and dₙ is the light intensity measured in a totally dark environment.

Therefore, in order to have an accurate absorbance, we must measure the light intensity in both “dark” and “vacuum” environment.

Since dₙ is close to zero, Eq. (2) can be further simplified as

$${A}_{n} = - log ( \frac{{s}_{n}}{{v}_{n}} ) n = 1 , 2 , … , N$$

The value of Aₙ is always non-negative since vₙ≧sₙ for n=1, 2, . . . , N. Eq. (2) provides a physical basis for the calculation of spectral absorbance. To actually calculate the absorbance Aₙ, one must measure the light intensity in a “vacuum” environment to obtain sₙ, termed as vacuum reference signal.

Since no vacuum reference signal can be obtained in an open-path spectroscopic remote sensing, absorbance Aₙ cannot be readily calculated using Eq. (3). Here we disclose a method used to estimate the vacuum reference signal.

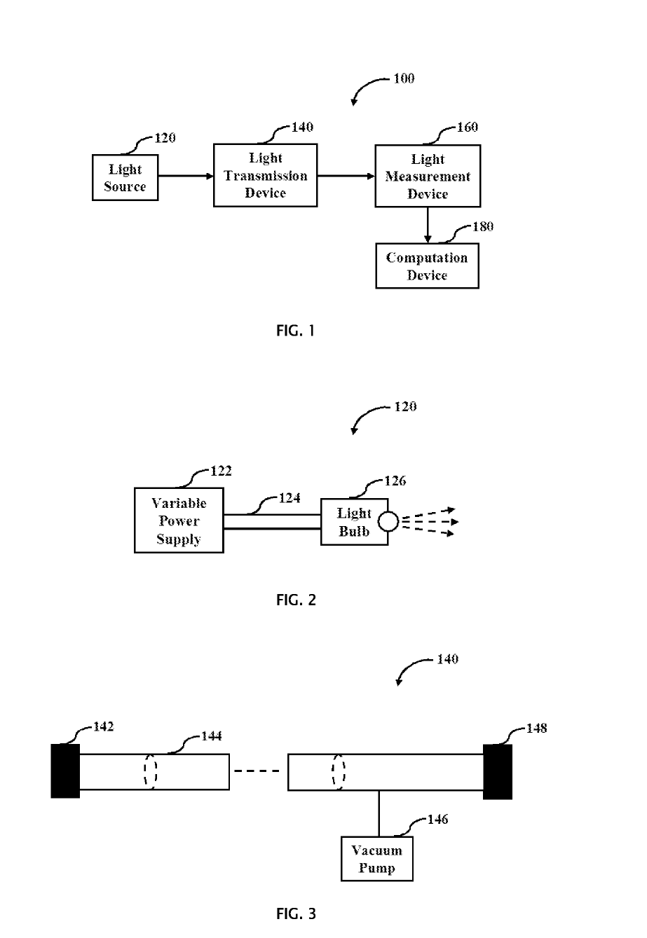

FIG. 1 shows an overall system structure 100 utilizing the invention in this disclosure. The device 120 is referred to a light source that can be as simple as a flash light, or as complex as a solar simulator, etc. The invention utilizes this light source to generate the light at desired intensities. A light transmission device 140 is used to pass the light generated by light source 120 to a downstream light measuring device 160. This light transmission device can be a pipe with different geometric shapes. The size of device 140 is determined by the cross section size of the light source. A light measurement device 160 is used to measure the light intensity in units such as photon counts. Such a device can be a spectrometer operating in various wavelength ranges. Finally a computation device 180 is used to collect the light intensities and make necessary scientific computations. This computation device 180 can be in various forms such as a laptop computer, a desktop computer, or a specialized microprocessor device, etc.

### Light Source

Refer to FIG. 2. The invention in this disclosure is primarily developed to obtain a set of vacuum reference signals mimic different sunlight intensities during different time of a day and during different weather conditions. The light bulb 126 typically operates under a fixed level of external voltage or current. In this disclosure, a variable power supply 122 is used to provide the desired power voltage and current. The light bulb receives the variable power through the power cable 124. The variable power supply will provide the light bulb with the desired types of power such as DC or AC voltage or current. By slightly changing the output voltage of variable power supply 122, the light intensities of light bulb 126 can be adjusted.

### Light Transmission

Refer to FIG. 3. A pipe 144 made of any materials can be used to pass light from the light source 120 to light measurement device 160. The shape of pipe 144 can be circular, rectangular, or any other shapes. There are two fixtures at both sides of pipe 144. The fixture 142 is used to connect the pipe 144 to the light source 120. The other fixture 148 is used to connect the pipe to the light measurement device 160. To generate vacuum in the pipe, a vacuum pump 146 is connected to the pipe 144 through a small tube. Both fixtures are firmly attached to the pipe 144, light source 120 and light measurement device 160 such that a certain level of vacuum pressure can be reached inside the pipe 144. The fixtures 142 and 148 are designed such that regular air can fill in the pipe 144 when vacuum pump 146 is turned off.

### Light Measurement

Light measurement device 160 can be any devices capable of measuring the light intensities. For example, a spectrometer can be used. The choice of this device is solely based on applications in interest.

### Computation Device

The computation device 180 is used to collect light measurement from the light measurement device 160 through a predefined I/O interface. The absorbance calculation can be done in this device.

### Vacuum Reference Collection

As we change the output voltage or current of the variable power supply 122, light intensity from light bulb changes as well, or equivalently, photon counts measured by the light measurement device 160 change. Let Δ be the smallest possible change in photon counts. Δ can be estimated through a series of experiments by varying the power supply output voltage/current and observing the changes in photon counts. Since the light measurement device 160, light bulb 126, and variable power supply 122 operate in certain error tolerances, the photon counts measurement contain noises. The appropriate value of Δ must be larger than the noise band.

Let Sₘᵢₙ and Sₘₐₓ be the upper and lower limits of photon counts for specific applications. The number of vacuum references can be calculated using the following equation:

M=round((Sₘₐₓ−Sₘᵢₙ)/Δ) (4)

where the function round( ) converts a real number to an integer. For the ith pipe reference, for i=1, 2, . . . , M, the photon counts will be Sₘᵢₙ+iΔ.

The procedure of measuring ith vacuum reference for i=1, 2, . . . , M is listed as follows:
Step 1
   Arrange the experiment system as shown in FIG. 1.
Step 2
   Fill the pipe 144 with ambient air until the air pressure in the pipe 144 reaches the steady state.
Step 3
   Adjust the output voltage or current of variable power supply 122 to a level such that photon counts measured by the light measurement device 160 are at Sₘᵢₙ+iΔ.
Step 4
   Record photon counts in the entire wavelength range. This recorded photon counts are referred to as pipe reference.
Step 5
   Turn on the vacuum pump 146 while keeping the output voltage or current of variable power supply 122 fixed. Wait until the vacuum pressure in the pipe 144 reaches to the maximum vacuum pressure allowed by the vacuum pump 146.
Step 6
   Record photon counts in the entire wavelength range. This recorded photon counts are referred to as the vacuum reference.

Repeat Steps 1-6 to obtain the rest of pipe references and vacuum references. For total M pipe and vacuum references, two libraries will be built: LIBₚᵢₚₑ and LIB_{vacuum}. LIBₚᵢₚₑ will have M pipe references while LIB_{vacuum} has M_{vacuum} references. All references in both libraries are arranged in either ascending or descending order. They are also indexed for fast retrieval.

Refer to FIG. 4A. A set of pipe references are recorded when photon counts vary from about 500 to 600. The corresponding vacuum references are given in FIG. 4B. For one pipe reference, the values of corresponding vacuum reference are always larger.

### Absorbance Calculation

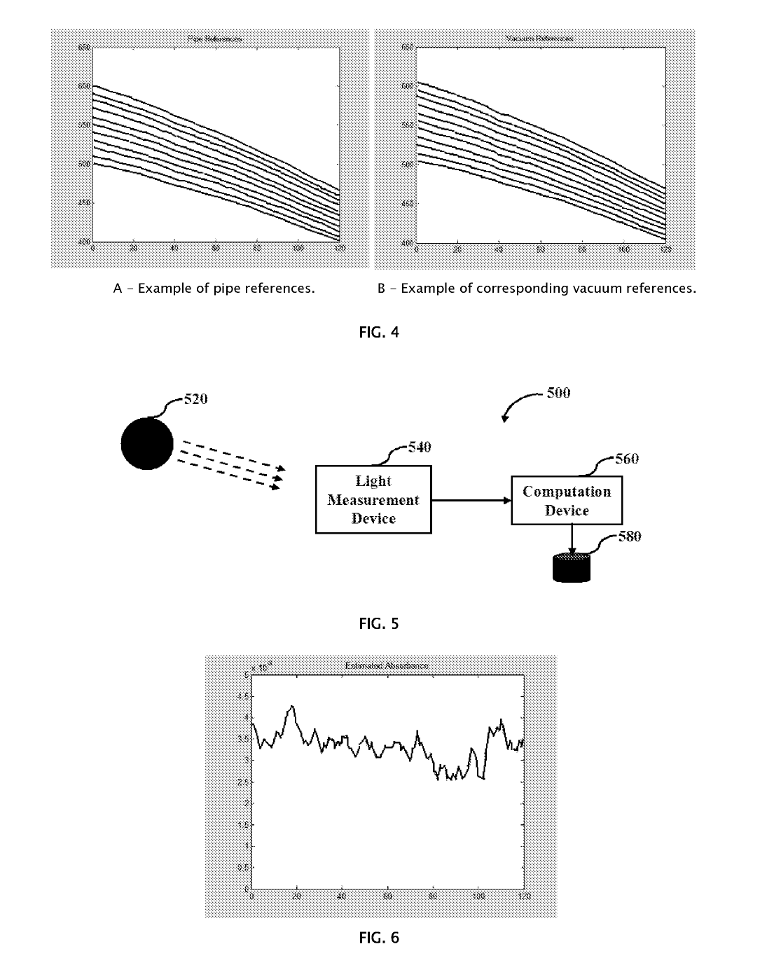

Refer to FIG. 5. The light measurement device 540 measures the photon counts from the sun 520. Through I/O links, it transfers the photon counts to the computation device 560 which, in turn, saves the measurement to database 580. In this disclosure, this measurement is termed as solar reference.

Refer to Eq. (3). The solar reference, {sᵢ, i=1, 2, . . . , N}, is the actual sunlight photon counts measured at difference wavelength. Its corresponding vacuum reference is required to calculate the absorbance.

The procedure of estimating corresponding vacuum reference is listed as follows:
Step 1
   Measure and record solar reference.
Step 2
   Use this solar reference to search the pipe reference library, LIBₚᵢₚₑ, and select one pipe reference which is mostly close to the solar reference measured. Some mathematical matching algorithms can be applied.
Step 3
   Find the index of matched pipe reference in LIBₚᵢₚₑ. Use this index to retrieve the corresponding vacuum reference in LIB_{vacuum}.
Step 4
   Use this vacuum reference in Eq. (3) to calculate the absorbance associated with solar reference measured in Step 1.

FIG. 6 shows an example of estimated absorbance following Steps 1-4.

Although this invention has been described according to an exemplary embodiment, it should be understood by those of ordinary skill in the art that modifications may be made without departing from the spirit of the invention. The scope of the invention is not to be considered limited by the description of the invention set forth in the specification, but rather as defined by our claims.

What are claimed are:

1. The way that spectral absorbance is calculated. The spectral absorbance calculation is based on Beer-Lambert's Law which requires photon counts in both open and vacuum environment. Since it is virtually impossible to measure the sunlight photon counts in the vacuum environment due to the varying path length, this invention essentially provides a practical way to estimate the sunlight photon counts in the vacuum environment in any time of a day under any weather conditions, thus, making the absorbance calculation in real-time possible.

2. The way that solar photon counts, termed as solar reference, in an open outdoor environment are collected. The actual solar counts in a typical sunny day can be measured by a typical spectrometer over a long period of time (e.g., 6:00 AM to 8:00 PM). The time period is chosen such that the measured photon counts must cover the largest photon counts in any sunny day all year long and lowest photon counts in the worst weather day, except at night, all year long. Depending on the spectrometer resolutions, there will be many readings. Therefore, averaging is necessary to build a solar reference library with limited number of solar photon count scans.

3. The way that solar reference is matched with pipe reference through lab experiments. A pipe, or any other devices, is used in the experiment. The pipe can be as long as 10 feet. Its actual length and opening size are not essential. One end of the pipe is attached to the spectrometer, the other end is open for the light source. For one solar reference, the light source is adjusted such that the photon counts of light source through the pipe or similar devices are as close to the selected solar reference as possible. Once this matching is done, the light source is fixed in both position and intensity. The photon count scan of light source through the pipe is termed as pipe reference.

4. The way that vacuum solar photon counts are estimated through experiments. Once the pipe reference is matched with the selected solar reference, a vacuum pump is used to make the air pressure in the pipe to be as close to vacuum as possible. While the vacuum pump is removing the air from the pipe, the light source must be fixed in both position and intensity. When the desired vacuum level is reached, the photon counts measured by the spectrometer are recorded, which, termed as vacuum reference, will be the estimated solar vacuum reference for the solar reference selected from the library at the beginning of this experiment.

5. The way that vacuum solar reference library is constructed through experiments. In the way identical to the estimation of one solar vacuum reference, a new solar reference is selected from the library and its vacuum solar reference is estimated through the appropriate pipe reference. This procedure is repeated for all solar references in the library collected in claim 2. In this way, a complete solar vacuum references are constructed.

6. The way that spectral absorbance is calculated. At one particular time of a day under one particular weather condition, the solar photon counts are measured by the spectrometer, which is compared with all pipe references constructed in the lab as stated in claim 3. Based on certain matching criteria such as minimum error between two references, the closest pipe reference is selected from the library and the corresponding vacuum reference constructed in claim 4 and claim 5 is selected as well. This vacuum reference is served as the estimated solar vacuum reference under the current measuring condition. Based on Beer-Lambert's law, the spectral absorbance is calculated. This calculated absorbance will be subsequently used for methane (CH₄) or other species detection and classification.

7. The way spectral absorbance is calculated is independent on the species of interest. In other words, the absorbance calculated in this patent disclosure can be used to detect and classify any species mixed in the absorbance calculated. For example, water vapor (H₂O) and oxygen (O₂), common species in the air, can be detected and classified. In fact, the calculated absorbance can be used for any other purposes since it is mixed with species in the air under any circumstances.

8. The references matching criteria can be any signal matching algorithms, mathematical or statistical. Moreover, the matching can take place for the entire reference, portion of the beginning of the reference, portion of the end of the reference, or any portion of the reference. This matching process is claimed as it is the key to the estimation of solar vacuum references which are impossible to measure in practice.

9. This invention details how a pipe is used for the reference library construction. It is noted that other devices can be used as well. These devices can be in various shapes, material composites, etc. Any devices used for the purposes of obtaining the references, thus, estimating solar vacuum references, are claimed as it is the essential part of the entire experiments for the construction of reference libraries.
